(19) United States
(12) Patent Application Publication
(10) Pub. No.: US 2025/0122839 A1
(43) Pub. Date: Apr. 17, 2025

(54) OVER-PRESSURE VENT SYSTEM FOR AN AIRCRAFT FUEL TANK

(71) Applicant: The Boeing Company, Arlington, VA (US)

(72) Inventors: Ivana Jojic, Bellevue, WA (US); Timothy Andrew Johnson, Issaquah, WA (US); Andrew T. Johnson, Everett, WA (US); David A. Ryan, Snohomish, WA (US); Melissa A. Pilla, Woodinville, WA (US); Bipin Giri, Bothell, WA (US); David Allen Adkins, II, Seattle, WA (US)

(73) Assignee: The Boeing Company, Arlington, VA (US)

(21) Appl. No.: 18/936,280

(22) Filed: Nov. 4, 2024

Related U.S. Application Data
(63) Continuation of application No. 17/691,080, filed on Mar. 9, 2022.

(51) Int. Cl. F02C 7/232; B64D 37/32; G05D 16/10

(52) U.S. Cl. CPC F02C 7/232; B64D 37/32; G05D 16/10

(57) ABSTRACT

An over-pressure vent (OPV) system is provided for a fuel tank of an aircraft. The OPV system includes an OPV valve configured to be coupled in fluid communication with a supply line of a nitrogen enriched air distribution system (NEADS) such that the OPV valve is configured to vent pressure from the supply line. The OPV valve is configured to be coupled in fluid communication with the supply line upstream from an outlet of the supply line from which the NEADS delivers nitrogen enriched gas to the fuel tank. The OPV valve is configured to sense a pressure within the supply line upstream from the outlet of the supply line.

### CROSS-REFERENCE TO RELATED APPLICATION

This application is a continuation application of and claims priority to U.S. patent application Ser. No. 17/691,080, entitled, “OVER-PRESSURE VENT SYSTEM FOR AN AIRCRAFT FUEL TANK,” filed on Mar. 9, 2022, the disclosure of which is incorporated herein by reference in its entirety.

### BACKGROUND

It is known to supply an inerting gas, such as nitrogen-enriched air (NEA), to the ullages (i.e., the portion of a tank above the liquid) of an aircraft fuel tank to prevent the tank from combusting. However, failures in the Nitrogen Generation System (NGS), the Nitrogen Enriched Air Distribution System (NEADS), the fuel system (e.g., sensed through the NEADS transport elements), and/or other systems can over-pressurize the fuel tank. Over-pressurization of an aircraft fuel tank in flight can lead to loss of structural integrity and is considered a potentially catastrophic hazard.

### SUMMARY

In one aspect, an over-pressure vent (OPV) system is provided for a fuel tank of an aircraft. The OPV system includes an OPV valve configured to be coupled in fluid communication with a supply line of a nitrogen enriched air distribution system (NEADS) such that the OPV valve is configured to vent pressure from the supply line. The OPV valve is configured to be coupled in fluid communication with the supply line upstream from an outlet of the supply line from which the NEADS delivers nitrogen enriched gas to the fuel tank. The OPV valve is configured to sense a pressure within the supply line upstream from the outlet of the supply line.

In another aspect, a nitrogen enriched air distribution system (NEADS) includes a supply line having an outlet configured to be coupled in fluid communication with a fuel tank. The supply line is configured to deliver nitrogen enriched gas to the fuel tank through the outlet. The NEADS includes an over-pressure vent (OPV) valve coupled in fluid communication with the supply line such that the OPV valve is configured to vent pressure from the supply line. The OPV valve is coupled in fluid communication with the supply line upstream from the outlet of the supply line. The OPV valve is configured to sense a pressure within the supply line upstream from the outlet of the supply line.

In another aspect, a method of venting pressure from a nitrogen enriched air distribution system (NEADS) of a fuel tank is provided. The method includes coupling an over-pressure vent (OPV) valve in fluid communication with a supply line of the NEADS upstream from an outlet of the supply line through which the supply line delivers nitrogen enriched gas to the fuel tank; sensing a pressure within the supply line upstream from the outlet of the supply line; and operating the OPV valve to vent pressure from the supply line upstream from the outlet of the supply line based on the pressure sensed within the supply line.

### BRIEF DESCRIPTION OF THE DRAWINGS

FIG. 1 is a schematic diagram of a nitrogen enriched air distribution system (NEADS) for a fuel tank of an aircraft illustrating an over-pressure vent (OPV) system according to an implementation.

FIG. 2 is a schematic diagram illustrating an OPV valve of the OPV system shown in FIG. 1 according to an implementation.

FIG. 3 is a schematic diagram illustrating an OPV valve according to another implementation.

FIG. 4 is a schematic diagram illustrating an OPV valve according to another implementation.

FIG. 5 is a schematic diagram illustrating an OPV system according to another implementation.

FIG. 6 is a schematic diagram illustrating an OPV system according to another implementation.

FIG. 7 is a perspective view of a surge tank of an aircraft illustrating an OPV valve of the OPV system shown in FIG. 6 according to an implementation.

FIG. 8 is a flow chart illustrating a method of venting pressure from a NEADS of a fuel tank according to an implementation.

FIG. 9 is a schematic view of an implementation of an aircraft.

### DETAILED DESCRIPTION

The foregoing summary, as well as the following detailed description of certain implementations will be better understood when read in conjunction with the appended drawings. While various spatial and directional terms, such as “top,” “bottom,” “upper,” “lower,” “vertical,” and the like are used to describe implementations of the present application, it is understood that such terms are merely used with respect to the orientations shown in the drawings. The orientations can be inverted, rotated, or otherwise changed, such that a top side becomes a bottom side if the structure is flipped 180°, becomes a left side or a right side if the structure is pivoted 90°, and the like.

Aircraft fuel tank vent systems are designed to facilitate equalizing the pressure in wing fuel tanks. In some aircraft, the wing fuel tanks are further distinguished between the main wing fuel tanks, which are located fully in the wings of the airplane, and the center wing tank, which is between the main fuel tanks, and is partially contained within the fuselage. During the climb phase, as the aircraft's altitude increases, atmospheric pressure decreases and the air above fuel within the tank is directed through the vent system into the surge tanks, which are located in each wing outboard of the main fuel tanks, and vented overboard (e.g., through a vent scoop, etc.).

During flight of an aircraft, operational conditions (e.g., maneuvers, etc.) and/or failures (e.g., failures in the Nitrogen Generation System (NGS), the Nitrogen Enriched Air Distribution System (NEADS), the fuel system, other systems, etc.) can cause over-pressurization of the fuel tank(s) of the aircraft. Over-pressurization of an aircraft fuel tank in flight can lead to loss of structural integrity and is considered a potentially catastrophic hazard.

Pressure relief valves, which are located in surge tanks outboard of the main fuel tank end rib, open when the allowable difference between surge tank pressure and atmospheric pressure is exceeded. However, such pressure relief valves would not relieve in scenarios where the venting is inhibited between the main and surge tanks (e.g., vent climb port covered and float valve/dive port failed and/or covered, such as in dual vent transition where the venting of the main tanks transitions from the float valves to the climb ports due to outboard fuel movement during takeoff/climb or in negative “g” scenarios where all vents are momentarily covered in fuel, etc.).

Overpressure conditions exist for both the center and main fuel tanks, but because the main fuel tanks are typically smaller in volume and less inerting air is distributed to them in normal conditions, there are more conditions where the improper distribution of nitrogen enriched air (NEA) could lead to overpressure of the main fuel tanks.

Certain implementations provide an over-pressure vent (OPV) system for a fuel tank of an aircraft. The OPV system includes an OPV valve configured to be coupled in fluid communication with a supply line of a nitrogen enriched air distribution system (NEADS) such that the OPV valve is configured to vent pressure from the supply line. The OPV valve is configured to be coupled in fluid communication with the supply line upstream from an outlet of the supply line from which the NEADS delivers nitrogen enriched gas to the fuel tank. The OPV valve is configured to sense a pressure within the supply line upstream from the outlet of the supply line.

Certain implementations provide OPV systems that operate in an unconventional manner to sense an over-pressurization of a fuel tank and divert nitrogen-enriched gas flow overboard via an OPV valve. Certain implementations provide savings in fuel tank over-pressure analysis non-recuring costs, reduce certification risks compared to architectures that limit inerting air into the fuel tank based on failure conditions and/or vent architectures that increase design space where limitations are needed (e.g., flights with covered main and/or center tank climb ports, etc.), and reduce confined space work and software complexity compared to systems that use in-tank components.

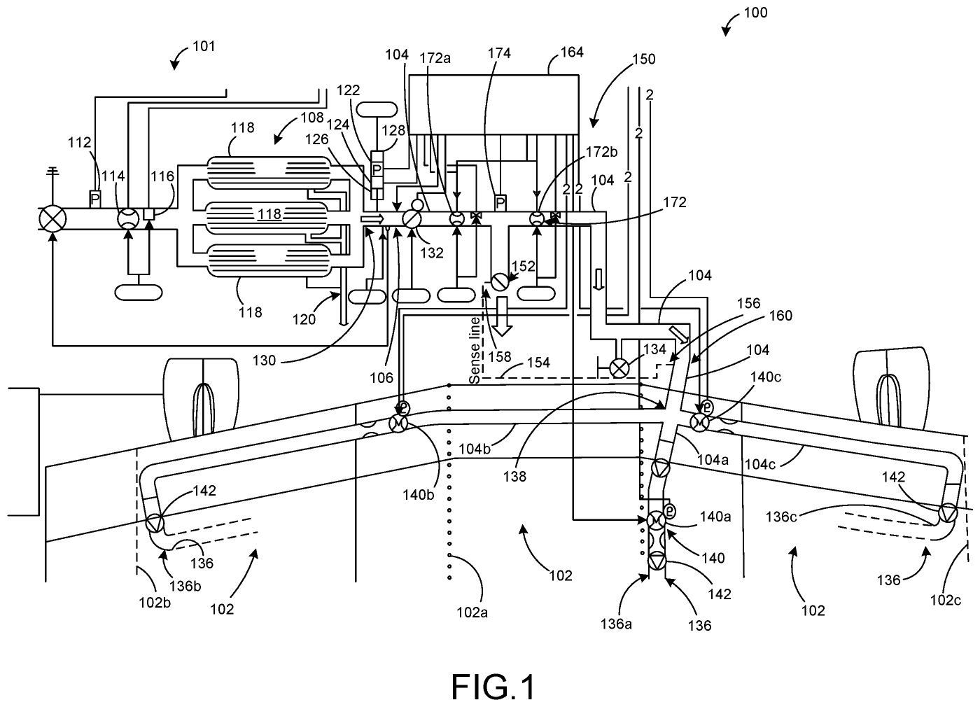

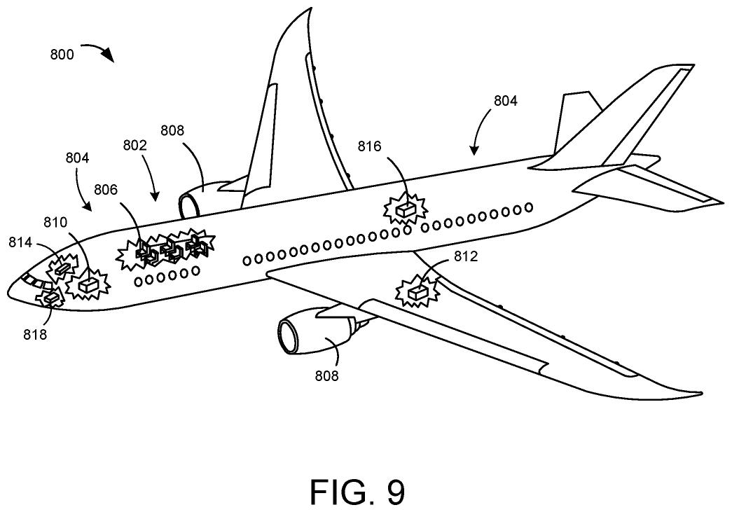

With references now to the figures, a schematic view of a NEADS 100 for a fuel tank 102 of an aircraft (e.g., the aircraft 800 shown in FIG. 9, etc.) is provided in FIG. 1. The NEADS 100 includes a supply line 104 that has an inlet 106. An NGS 101 of the aircraft includes a gas separation module (GSM) assembly 108 coupled in fluid communication with a gas source (not shown; e.g., ambient air, gas supplied from a heat exchanger, gas supplied from a compressor, etc.) for receiving a flow of gas (e.g., air) having a nitrogen component and an oxygen component. In some implementations, a system shut-off valve (not shown) is operatively connected between the GSM assembly 108 and the gas source for selectively controlling operation of the NGS 101, the NEADS 100, and/or the like (e.g., for selectively allowing gas to flow through the inlet 106 and into the supply line 104 of the NEADS 100, etc.).

In some implementations, a pressure sensor 112, a flow rate sensor 114, and/or a temperature sensor 116 is operatively connected upstream from the GSM assembly 108 to measure a respective pressure, flow rate, and/or temperature of gas supplied to the GSM assembly 108.

The GSM assembly 108 includes one or more gas separation modules 118 that separate the received gas flow into a nitrogen-enriched gas flow and an oxygen-enriched gas flow. The oxygen-enriched gas flow is discharged from the GSM assembly 108 through an outlet 120 as waste gas, or alternatively, for use providing breathable air to passenger and/or flight crew compartments (not shown).

In some implementations, one or more pressure sensors 122, one or more flow rate sensors 124, one or more oxygen sensors 126, and/or one or more temperature sensors 128 are operatively connected downstream from an outlet 130 of the GSM assembly 108 to measure a respective pressure, flow rate, oxygen amount, and/or temperature of the nitrogen-enriched gas flow discharged from the GSM assembly 108.

As shown in FIG. 1, the inlet 106 of the NEADS 100 is coupled in fluid communication with the outlet 130 of the GSM assembly 108 for receiving a nitrogen-enriched gas flow from the GSM assembly 108 into the supply line 104 of the NEADS 100. In some implementations, the NEADS 100 includes a flow control valve 132 that is operatively connected to (e.g., coupled in fluid communication with) the supply line 104 downstream from the outlet 130 of the GSM assembly 108 to control a flow rate of the nitrogen-enriched gas flow received from the GSM assembly 108 into the supply line 104. In some implementations, the flow control valve 132 is a two-position valve having an open position allowing a first (e.g., higher, etc.) flow rate of the nitrogen-enriched gas to flow downstream from the flow control valve 132, and a closed position allowing a second (e.g., lower, zero, etc.) flow rate of the nitrogen-enriched gas to flow downstream from the flow control valve 132. In other implementations, the flow control valve 132 has a continuum of positions producing any number and/or combination of flow rates of the nitrogen-enriched gas flow downstream from the flow control valve 132.

Some implementations of the NEADS 100 include a ground connection port 134 that is operatively connected to the supply line 104 downstream from the GSM assembly 108, for example: (1) to allow for testing for, and/or drainage of, fuel that has migrated from the fuel tank 102 into the supply line 104; (2) to allow the withdrawal of nitrogen-enriched gas from the nitrogen-enriched gas flow generated by the NEADS 100; (3) for draining the NEADS 100 of nitrogen-enriched gas; and/or (4) for introducing nitrogen-enriched gas from a nitrogen-enriched gas source (not shown) external to the aircraft to the fuel tanks 102 instead of, or in addition to, the nitrogen-enriched gas flow generated by the GSM assembly 108 (e.g., to enable the NEADS 100 to operate without electrical power when supplied with compressed gas from the pre-conditioned gas-source, etc.).

The supply line 104 of the NEADS 100 includes one or more outlets 136 coupled in fluid communication with the fuel tanks 102 such that the supply line 104 is configured to deliver the nitrogen-enriched gas flow generated by the GSM assembly 108 to the fuel tanks 102 through the one or more outlets 136. In the exemplary implementation, the NEADS 100 serves the center fuel tank 102a and both main wing fuel tanks 102b and 102c of the aircraft. Accordingly, in the exemplary implementation shown in FIG. 1, the supply line 104 branches off at a junction 138 into three branches 104a, 104b, and 104c having three outlets 136a, 136b, and 136c that are coupled in fluid communication with the respective fuel tanks 102a, 102b, and 102c. In other implementations, the NEADS 100 serves a different number of fuel tanks 102 (e.g., one of the fuel tanks 102, two of the fuel tanks 102, etc.) such that the supply line 104 includes a different number of branches (e.g., a single branch, two branches, etc.) and a different number of the one or more outlets 136 (e.g., one of the one or more outlets 136, two of the one or more outlets 136, etc.). Each of the outlets 136a, 136b, and 136c may be referred to herein as a “first” and/or a “second” outlet.

Each branch 104a, 104b, and 104c of the supply line 104 includes a respective isolation valve 140a, 140b, and 140c that is operatively connected to (e.g., coupled in fluid communication with) the supply line 104 to control the flow of nitrogen-enriched gas into the respective fuel tank 102a, 102b, and 102c. In some implementations, an isolation valve 140 is a two-position valve having an open position allowing a first (e.g., higher, etc.) flow rate of the nitrogen-enriched gas into the corresponding one of the fuel tanks 102, and a closed position allowing a second (e.g., lower, zero, etc.) flow rate of the nitrogen-enriched gas into the corresponding one of the fuel tanks 102. In some implementations, an isolation valve 140 has a multiplicity of positions producing any number and/or combination of flow rates of the nitrogen-enriched gas flow into the corresponding one of the fuel tanks 102. Optionally, one or more of the branches 104a, 104b, and/or 104c of the supply line 104 includes a check valve 142.

The NEADS 100 includes an over-pressure vent (OPV) system 150. The OPV system 150 is configured to sense the pressure within the fuel tanks 102 and divert nitrogen-enriched gas flow overboard via an OPV valve 152 (described below) that is located within the NEADS 100 upstream of the fuel tank penetration (i.e., the one or more outlets 136). Operation of the OPV system 150 is based on the pressure in the NEADS supply line being related to the pressure within the fuel tanks 102 (e.g., tank pressure+line and component Δp, etc.). For example, a change in flow distribution between the fuel tanks 102 (e.g., due to an isolated, flow restricted, and/or blocked branch, etc.) may result in pressure changes within the NEADS supply line. Accordingly, the OPV system 150 is configured to sense the pressure within the supply line 104 upstream from the one or more outlets 136 and vent pressure from the supply line 104 based on the pressure sensed within the supply line 104 (e.g., when the sensed pressure within the supply line 104 indicates an over-pressurization of the fuel tank 102, etc.).

As briefly described above, the OPV system 150 includes the OPV valve 152. The OPV valve 152 is configured to sense a pressure within the supply line 104 of the NEADS 100 and an atmospheric pressure reference. The pressure difference between the sensed pressure within the supply line 104 and the atmospheric pressure reference is the proxy for the pressure difference (with respect to atmospheric pressure) that is experienced by the fuel tanks 102.

In the exemplary implementation of FIG. 1, the OPV valve 152 is a regulating valve that is operatively connected to (e.g., is coupled in fluid communication with) the supply line 104 such that the OPV valve 152 is configured to vent pressure from the supply line 104. The OPV valve 152 is positioned upstream from the one or more outlets 136 of the supply line 104 and downstream from the outlet 130 of the GSM assembly 108. In other words, the OPV valve 152 is coupled in fluid communication with the supply line 104 upstream from the one or more outlets 136 of the supply line 104 and downstream from the outlet 130. Accordingly, the OPV valve 152 is configured to vent pressure of the nitrogen-enriched gas flow discharged from the GSM assembly 108 from the supply line 104 upstream from the one or more outlets 136.

In some implementations, the OPV valve 152 has a dedicated venting location on the aircraft (e.g., a fairing penetration, into an unpressurized compartment of the aircraft, etc.). A dedicated venting location may enable optimization of the venting location to facilitate minimizing the pressure difference between a fuel tank reference ambient and an altitude reference. In some implementations, in addition or alternatively to a dedicated venting location, integrated venting may be used. For example, venting of the OPV valve 152 can be combined with venting of the oxygen-enriched gas flow through the outlet 120. Integrated venting may minimize the number of fairing penetrations of the aircraft. However, due to fluid flow through the integrated outlet in some implementations, pressure in the integrated outlet is higher than ambient and may vary depending on the flow mode, which may impact and add to the tolerances that need to be considered in the valve design.

As described above, the OPV valve 152 is configured to sense an atmospheric pressure reference. In some implementations, the atmospheric pressure reference is sensed via a pneumatic line (not shown) that is coupled in fluid communication between the OPV valve 152 and the atmosphere (e.g., via a fairing penetration, etc.) and/or an unpressurized compartment of the aircraft. In other implementations, sensing of the atmospheric pressure reference is signal-based (mechanical and/or electrical). For example, the OPV system 150 may include a pressure sensor (not shown; e.g., a digital pressure sensor, an analog pressure sensor, etc.) operatively connected to the OPV valve 152 (and/or an optional controller; e.g., the controller 164 described below, etc.). The pressure sensor is configured to read the atmospheric pressure reference such that the OPV valve 152 receives an electrical or optical signal from the pressure sensor that indicates the atmospheric pressure reference.

As is also described above, the OPV valve is configured to sense the pressure within the supply line 104. In the exemplary implementation of FIG. 1, the OPV system 150 includes a pressure sense line 154 that is operatively connected between the supply line 104 and the OPV valve 152. The operative connection of the pressure sense line 154 between the OPV valve 152 and the supply line 104 enables the OPV valve 152 to sense the pressure within the supply line 104 through the pressure sense line 154. Specifically, the pressure sense line 154 extends a length from a line end portion 156 to a valve end portion 158. The line end portion 156 is operatively connected to the supply line 104 and the valve end portion 158 is operatively connected to OPV valve 152 such that the OPV valve 152 is configured to sense the pressure within the supply line 104 through the pressure sense line 154.

In some implementations, the pressure sense line 154 provides an electrical and/or mechanical signal. For example, the line end portion 156 of the pressure sense line 154 may include a pressure sensor (not shown; e.g., a digital pressure sensor, an analog pressure sensor, etc.) that is configured to read the pressure within the supply line 104 such that the OPV valve 152 receives an electrical or optical signal from the pressure sense line 154 that indicates the pressure read within the supply line 104. In some implementations, multiple pressure signals may be provided (e.g., which may be appropriate for architectures where the pressure drops are relatively high and where the proxy pressure difference with the sense line closer to the valve, with all tolerance stack ups, would encroach on the normal system operation, which would lead to valve opening in normal, rather than overpressure conditions, etc.).

In the exemplary implementation of FIG. 1, the pressure sense line 154 is a pneumatic line. For example, the OPV system 150 the exemplary implementation of the pressure sense line 154 is a pneumatic line that is operatively connected between the supply line 104 and the OPV valve 152. The fluid communication provided by the pressure sense line 154 enables the OPV valve 152 to mechanically sense the pressure within the supply line 104 through the pressure sense line 154. Specifically, the line end portion 156 is coupled in fluid communication with the supply line 104, and the valve end portion 158 is coupled in fluid communication with the OPV valve 152. Accordingly, the pressure sense line 154 provides a fluid path between the supply line 104 (at the location of the line end portion 156) and the OPV valve 152.

As shown in FIG. 1, the line end portion 156 of the pressure sense line 154 is operatively connected to the supply line 104 upstream from the one or more outlets 136 of the supply line 104 (and downstream from the OPV valve 152). Accordingly, the OPV valve 152 is configured to sense the pressure within the supply line 104 at a location along the supply line 104 that is upstream from the outlets 136 of the supply line 104 (and downstream from the OPV valve 152). In the exemplary implementation, the line end portion 156 of the pressure sense line 154 is operatively connected to the supply line 104, and thus the OPV valve 152 is configured to sense the pressure within the supply line 104, at a location 160 that is slightly upstream from the junction 138 at which the supply line 104 branches out to the different outlets 136a, 136b, and 136c, as can be seen in FIG. 1.

The pressure sense line 154 is not limited to being operatively connected to the supply line 104 at the location 160. Rather, the line end portion 156 of the pressure sense line 154 may be operatively connected to the supply line 104, and thus the OPV valve 152 may be configured to sense the pressure within the supply line 104, at any location along the supply line 104 that is upstream from the one or more outlets 136 of the supply line 104. The location along the supply line 104 at which the OPV valve 152 is configured to sense the pressure within the supply line 104 may be selected to facilitate operation of the OPV system 150. For example, the line end portion 156 of the pressure sense line 154 may be operatively connected to the supply line 104 at a location along the supply line 104 that is as close as possible to the one or more outlets 136 (i.e., the fuel tank penetration location) to minimize a pressure differential that must be accounted for between the fuel tank(s) 102 and the OPV valve 152. Moreover, and for example, the location along the supply line 104 at which the OPV valve 152 is configured to sense the pressure within the supply line 104 may be selected as upstream from, but as close as possible to, a junction (e.g., the junction 138, etc.) at which the supply line 104 branches off to different fuel tanks 102, for example as is shown in the exemplary implementation of FIG. 1. Locating the line end portion 156 of the pressure sense line 154 upstream from a junction at which the supply line 104 branches off to different fuel tanks 102 enables the OPV system 150 to serve a NEADS 100 that serves more than one fuel tank 102. For example, locating the line end portion 156 of the pressure sense line 154 upstream from a junction at which the supply line 104 branches off to different ones of the fuel tanks 102 enables the OPV system 150 to detect an overpressure scenario in any and all of the fuel tanks 102 that are served by the NEADS 100. In other implementations, one or more of the branches the NEADS supply line includes a dedicated OPV system 150 downstream from the junction at which the NEADS supply line (e.g., the supply line 104) branches off to different fuel tanks 102. It should be understood that although the OPV system 150 is shown and described herein for use with a NEADS 100 that serves more than one fuel tank 102, the OPV systems disclosed herein are equally applicable to NEADS that serve only a single fuel tank 102. In other words, in some implementations, the OPV system 150 is used to detect overpressure scenarios in only a single fuel tank 102.

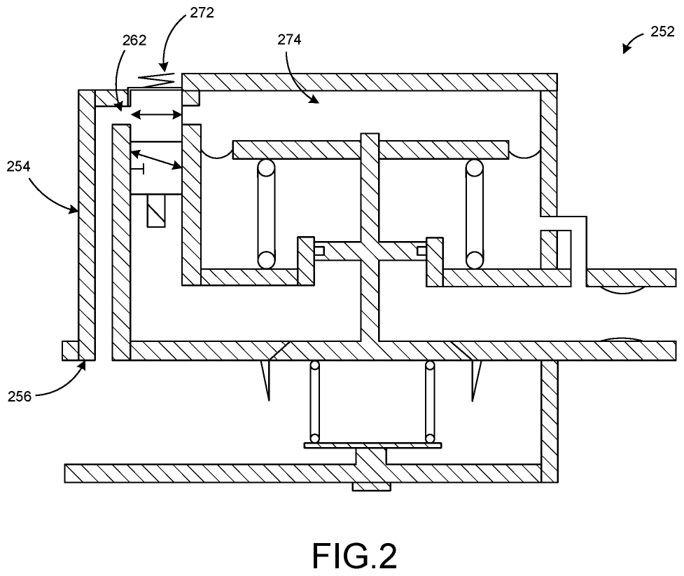

In some other implementations, the OPV valve 152 includes an integrated pressure sense line. For example, FIG. 2 illustrates an OPV valve 252 that includes a pneumatic pressure sense line 254 that is integrated into the OPV valve 252. The pneumatic pressure sense line 254 includes a line end portion 256 that is configured to be coupled in fluid communication with the supply line 104 (shown in FIG. 1). Accordingly, the pneumatic pressure sense line 254 provides a fluid path between the supply line 104 (at the location of the line end portion 256) and a pressure sense inlet 262 of the OPV valve 252. The fluid communication provided by the integrated pneumatic pressure sense line 254 enables the OPV valve 252 to mechanically sense the pressure within the supply line 104 through the pneumatic pressure sense line 254. In some implementations, the OPV valve 252 includes a pilot valve 272 coupled in fluid communication between an actuation chamber 274 of the OPV valve 252 and the pressure sense inlet 262. The pilot valve 272 can be selectively moved to block the pressure at the pressure sense inlet 262 so that the actuation chamber 274 vents to ambient.

As the pneumatic pressure sense line 254 is integrated into the OPV valve 252 as shown in FIG. 2, the line end portion 256 of the pneumatic pressure sense line 254 is operatively connected to the supply line 104 at the location of the OPV valve 252. Accordingly, the OPV valve 252 is configured to sense the pressure within the supply line 104 at the location along the supply line 104 of the OPV valve 252 (which is also upstream from the outlets 136 of the supply line 104). The pneumatic pressure sense line 254 may be suitable for implementations wherein sensing the pressure farther away from the fuel tanks 102 would not interfere with the normal operation of the OPV system 150 (e.g., when there is a sufficiently large difference between the wing allowable and the regulating pressure when all tolerances are accounted for, etc.). In some implementations, because the pressure within the supply line 104 is sensed farther away from the fuel tanks 102, the integrated pneumatic pressure sense line 254 may result in a lower accuracy as compared to a remote pressure sense line (e.g., the pneumatic pressure sense line 154 shown in FIG. 1, etc.).

Referring again to FIG. 1, in the exemplary implementation, the OPV valve 152 is a pneumatic mechanical valve that provides a direct response to physical phenomenon (e.g., over-pressure, etc.). In other words, no electrical actuation is required to power the regulating action of the OPV valve 152. Rather, an increase in pressure received from the pressure sense line 154 mechanically opens the OPV valve 152. In other implementations, the OPV valve 152 is an electromechanical valve, operation of which is controlled by a controller (e.g., the controller 164 described below, a digital controller, an analog controller, etc.). For example, the controller may receive a signal indicative of the pressure sensed within the supply line 104 and control operation of the OPV valve 152 (e.g., open the OPV valve 152 to vent pressure from the supply line 104, etc.) based on the received signal.

In some implementations (e.g., when the OPV valve 152 is a pneumatic mechanical valve, etc.), the OPV valve 152 includes a spring (not shown in FIG. 1) and/or other mechanism, arrangement, and/or the like (e.g., fluid pressure, a magnet, etc.) that is configured as a fail-safe that deactivates the OPV valve 152 such that a loss of power leaves the OPV valve 152 in an active position that enables the OPV valve 152 to regulate pressure and vent the gas flow.

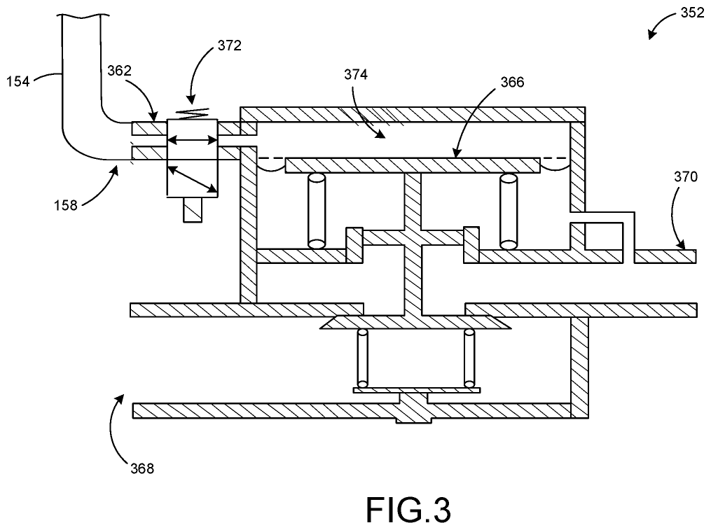

FIG. 3 illustrates one example of the exemplary implementation of the OPV valve 152. Specifically, FIG. 3 illustrates a pneumatic mechanical OPV valve 352 according to an implementation. The OPV valve 352 includes a single poppet 366. The OPV valve 352 includes a pressure sense inlet 362 that is configured to be coupled in fluid communication with the valve end portion 158 of the pressure sense line 154. The OPV valve 352 also includes a valve inlet 368 at which the OPV valve 352 is configured to be coupled in fluid communication with the supply line 104 (shown in FIG. 1) for venting pressure from the supply line 104. The OPV valve 352 is configured to vent pressure of the nitrogen-enriched gas flow from the supply line 104 through a vent outlet 370 of the OPV valve 352. The OPV valve 352 provides a direct response to an over-pressure within the supply line 104 received from the pressure sense line 154. In some implementations, the OPV valve 352 includes a pilot valve 372 coupled in fluid communication between an actuation chamber 374 of the OPV valve 352 and the pressure sense inlet 362. The pilot valve 372 can be selectively moved to block the pressure at the pressure sense inlet 362 so that the actuation chamber 374 vents to ambient.

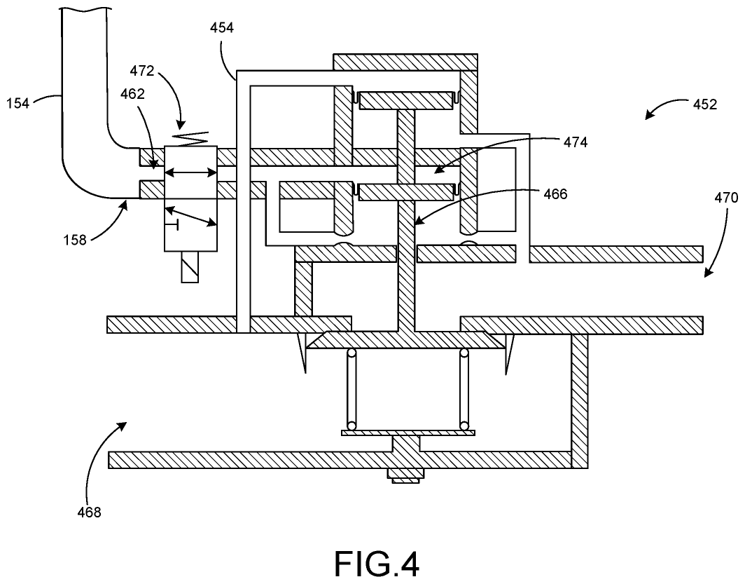

FIG. 4 illustrates another example of the exemplary implementation of the OPV valve 152. Specifically, FIG. 4 illustrates a pneumatic mechanical OPV valve 452 according to an implementation. The OPV valve 452 includes a dual poppet 466. The dual poppet design of the OPV valve 452 may be used when the OPV system 150 is designed for use with higher flow rates (e.g., higher mass flows may require a larger poppet area, etc.).

The OPV valve 452 includes a pressure sense inlet 462 that is configured to be coupled in fluid communication with the valve end portion 158 of the pressure sense line 154. In addition or alternatively, the OPV valve 452 includes an integrated pressure sense line (e.g., the integrated pressure sense line 454, the integrated pressure sense line 254 shown in FIG. 2, etc.). The OPV valve 452 also includes a valve inlet 468 at which the OPV valve 452 is configured to be coupled in fluid communication with the supply line 104 (shown in FIG. 1) for venting pressure from the supply line 104. The OPV valve 452 is configured to vent pressure of the nitrogen-enriched gas flow from the supply line 104 through a vent outlet 470 of the OPV valve 452. The OPV valve 452 provides a direct response to an over-pressure within the supply line 104 received from the pressure sense line 154. In some implementations, the OPV valve 452 includes a pilot valve 472 coupled in fluid communication between an actuation chamber 474 of the OPV valve 452 and the pressure sense inlet 462. The pilot valve 472 can be selectively moved to block the pressure at the pressure sense inlet 462 so that the actuation chamber 474 vents to ambient.

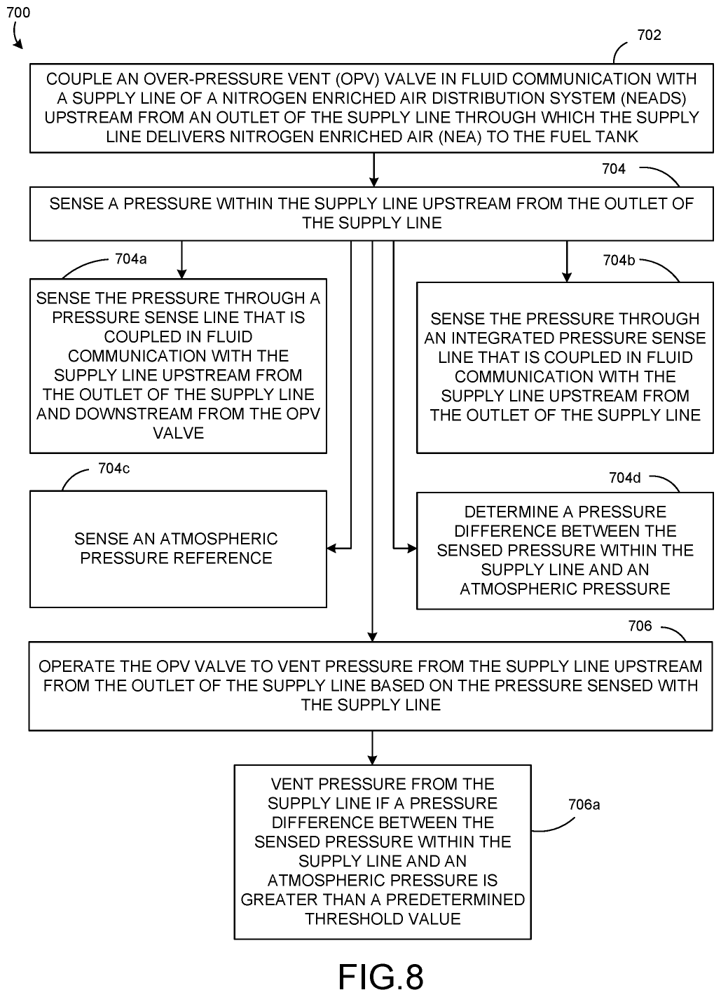

Referring again to FIG. 1, and as briefly described above, the OPV system 150 optionally includes a controller 164 that controls one or more operations of the OPV valve 152, any sensors (e.g., signal-based pressure sensors, etc.), and/or other components of the OPV system 150. In some implementations, the controller 164 is configured to execute some or all of the operations of the OPV systems disclosed herein and/or of the methods described herein with respect to FIG. 8 (e.g., operations of the OPV valves disclosed herein, built-in-test (BIT) procedures, health monitoring and prognostics of the OPV systems disclosed herein and/or other NEADS components, etc.). The controller 164 represents any device executing instructions (such as, but not limited to, as application programs/software, operating system functionality, functionality partitioned across one or more dedicated LRUs and/or GSEs, and/or the like) to implement the operations and functionality associated with the controller 164. In some implementations, the controller 164 includes a mobile electronic device or any other portable device, for example a mobile telephone, laptop, tablet, computing pad, netbook, and/or the like. In some implementations, the controller 164 includes less portable devices, for example desktop personal computers, servers, controllers, kiosks, tabletop devices, industrial control devices, and/or the like. The controller 164 represents a group of processing units, servers, other computing devices, and/or the like in some implementations. In some implementations, the controller 164 is a dedicated controller for the OPS system 150, while in other implementations a controller (not shown) of the NEADS 100 and/or another aircraft system includes the controller 164 (e.g., the operations performed by the controller 164 are performed by a portion of the controller of the NEADS 100 and/or other aircraft system).

The controller 164 includes one or more optional memories (not shown) and one or more processors (not shown; e.g., microprocessors, etc.) for processing computer executable instructions to control the operation of the controller 164. In some implementations, platform software comprising an operating system and/or any other suitable platform software is provided on the controller 164 to enable application software to be executed on the controller 164. Computer executable instructions are provided using any computer-readable media that are accessible by the controller 164. Computer-readable media include, for example and without limitation, computer storage media and communications media. Computer storage media, such as a memory, include volatile and non-volatile, removable, and non-removable media implemented in any method or technology for storage of information such as computer readable instructions, data structures, program modules or the like. Computer storage media include, but are not limited to, RAM, ROM, EPROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing apparatus. In contrast, communication media embody computer readable instructions, data structures, program modules, and/or the like in a modulated data signal, such as a carrier wave and/or other transport mechanism. As defined herein, computer storage media do not include communication media. Therefore, a computer storage medium should not be interpreted to be a propagating signal per se. Propagated signals per se are not examples of computer storage media.

In some implementations, the OPV system 150 includes one or more mass flow sensors 172 that are coupled in fluid communication with the supply line 104 of the NEADS 100 for sensing a flow rate within the supply line 104. In the exemplary implementation, the OPV system 150 includes two mass flow sensors 172a and 172b, with the OPV valve 152 being coupled in fluid communication with the supply line 104 between the mass flow sensors 172a and 172b. However, the OPV system 150 may include any other number of the mass flow sensors 172. Each of the mass flow sensors 172a and 172b may be referred to herein as a “first” and/or a “second” mass flow sensor.

Each mass flow sensor 172 is configured to sense the flow rate within the supply line 104 such that the controller 164 receives an electrical or optical signal from the mass flow sensor 172 that indicates the sensed flow rate within the supply line 104. Each mass flow sensor 172 may be any type of sensor that enables the mass flow sensor to sense the flow rate within the supply line 104 (e.g., with minimal or without flow disturbance, etc.), such as, but not limited to, an electrical sensor, a mechanical sensor, a digital sensor, an analog sensor, and/or the like.

In some implementations, the OPV system 150 includes one or more pressure sensors 174 that is operatively connected to the supply line 104 upstream from the OPV valve 152. The pressure sensor 174 is configured to sense the pressure within the supply line 104 such that the controller 164 receives an electrical or optical signal from the pressure sensor 174 that indicates the sensed pressure within the supply line 104. The pressure sensor 174 may be any type of sensor that enable the pressure sensor to sense the pressure within the supply line 104, such as, but not limited to, an electrical sensor, a mechanical sensor, a digital pressure sensor, an analog pressure sensor, and/or the like. In some implementations wherein the OPV system 150 includes two mass flow sensors 172 (e.g., the exemplary implementation shown in FIG. 1, etc.), the pressure sensor 174 is located upstream of the OPV valve 152 and between the two mass flow sensors 172a and 172b, for example as shown in FIG. 1.

The mass flow sensor(s) 172 and the pressure sensor 174 may be used, for example, by the controller 164 during a BIT procedure (e.g., as described below, etc.) and/or during health monitoring and prognostics of the OPV system 150 and/or other NEADS components.

In operation, the OPV system 150 is configured to sense the pressure within the fuel tanks 102 relative to atmospheric pressure and divert nitrogen-enriched gas flow overboard via the OPV valve 152 (e.g., in response to the sensed pressure, when desired, when necessary, as required, on-demand, etc.). Specifically, and as described above, operation of the OPV system 150 is based on the pressure in the NEADS supply line being related to the pressure within the fuel tanks 102 (e.g., tank pressure+line and component Δp, etc.). Accordingly, the OPV system 150 is configured to sense the pressure within the supply line 104 upstream from the one or more outlets 136 and vent pressure from the supply line 104 based on the pressure sensed within the supply line 104. For example, a pressure difference between the sensed pressure within the supply line 104 and the sensed atmospheric pressure that is greater than a predetermined threshold is indicative of an over-pressurization of at least one of the fuel tanks 102. Accordingly, the OPV system 150 is configured such that when the pressure difference between the sensed pressure within the supply line 104 and the sensed atmospheric pressure is greater than the predetermined threshold, the OPV valve 152 opens to vent pressure from the supply line 104 and thereby mitigate the over-pressurization situation. In the exemplary implementation, the OPV valve 152 is a pneumatic mechanical valve that is opened automatically by the pressure difference exceeding the predetermined threshold. In other implementations, the OPV valve 152 is opened by the controller 164 upon a determination by the controller 164 or another component of the OPV system 150 that the sensed pressure within the supply line 104 and the sensed atmospheric pressure is greater than the predetermined threshold.

The predetermined threshold of the pressure difference between the sensed pressure within the supply line 104 and the atmospheric pressure, as well as the size (e.g., operational flow rates, etc.) of the OPV valve 152, may be selected (e.g., including a factor of safety, etc.) based on a variety of different factors, such as, but not limited to: a pressure difference between one of the fuel tanks 102 and the atmosphere at which damage or structural failure will occur; an allowable wing structure pressure difference with respect to atmospheric; a maximum climb and/or cruise nitrogen-enriched gas flow when the overpressure threat is most likely; a normal (non-failure) NEADS supply line pressure in climb and/or cruise; and/or the like. In some implementations, the OPV valve 152 is configured to be deactivated (e.g., closed; e.g., by the controller 164, using a pilot valve, another type of pilot device, etc.) during a descent phase of flight, for example to facilitate preventing the OPV valve 152 from being triggered to vent due to the higher NEADS supply line pressures during descent, etc.

The OPV system 150 is thus configured to sense an over-pressurization of the fuel tank(s) 102 and divert nitrogen-enriched gas flow overboard via the OPV valve 152 to facilitate mitigating the over-pressure condition, which may reduce or prevent damage to the aircraft and/or structural failure of one or more components of the aircraft (e.g., a wing, a fuselage, a fuel tank, etc.) caused by an over-pressure situation.

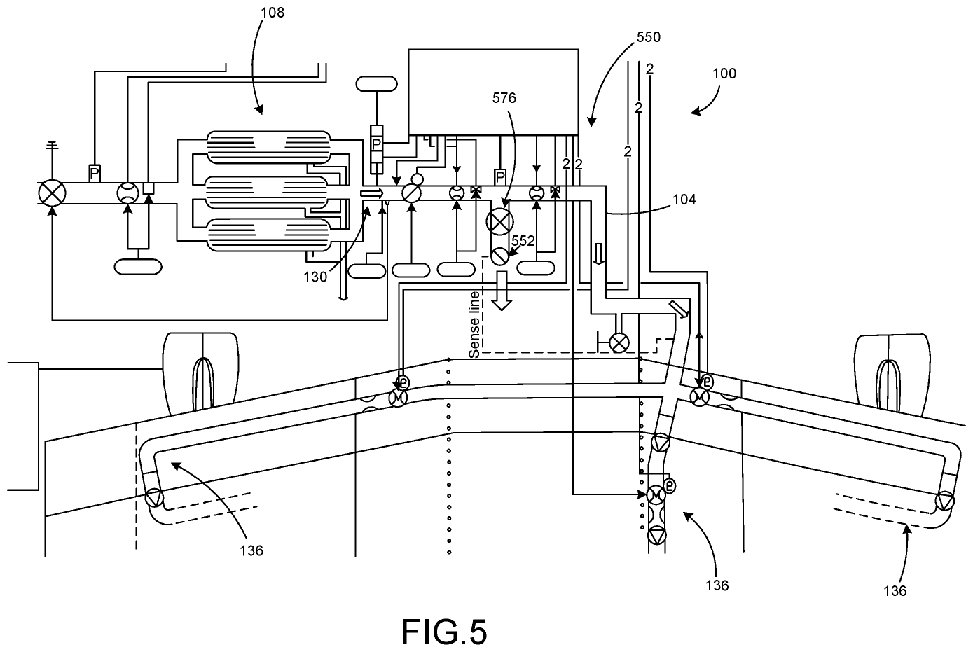

Referring now to FIG. 5, an OPV system 550 according to another implementation is illustrated. The OPV system 550 functions substantially similar to the OPV system 150 (shown in FIG. 1) to facilitate mitigating over-pressurization of the fuel tanks 102. For example, the OPV system 550 is configured to sense the pressure within the supply line 104 upstream from the one or more outlets 136 and vent pressure from the supply line 104 based on the pressure sensed within the supply line 104 (e.g., when the sensed pressure within the supply line 104 indicates an over-pressurization of the fuel tank 102, etc.).

In the exemplary implementation of FIG. 5, the OPV system 550 includes an OPV valve 552 that is a relief valve that is operatively connected to (e.g., is coupled in fluid communication with) the supply line 104 such that the OPV valve 552 is configured to vent pressure from the supply line 104. The OPV valve 552 is positioned upstream from the one or more outlets 136 of the supply line 104 and downstream from the outlet 130 of the GSM assembly 108. In other words, the OPV valve 552 is coupled in fluid communication with the supply line 104 upstream from the one or more outlets 136 of the supply line 104 and downstream from the outlet 130. Accordingly, the OPV valve 152 is configured to vent pressure of the nitrogen-enriched gas flow discharged from the GSM assembly 108 from the supply line 104 upstream from the one or more outlets 136.

In some implementations, the OPV system 550 includes an isolation valve 576 coupled in fluid communication upstream from the OPV valve 552. The isolation valve 576 can be operated to deactivate (e.g., close) the OPV valve 552 during a descent phase of flight, for example to facilitate preventing the OPV valve 552 from being triggered to vent due to the higher NEADS supply line pressures during descent, etc.

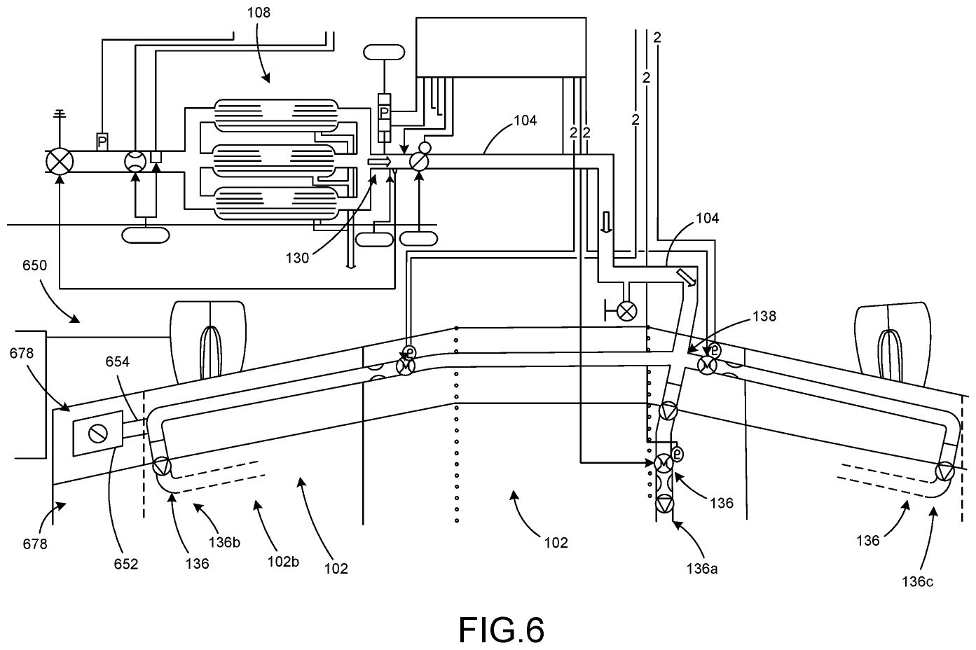

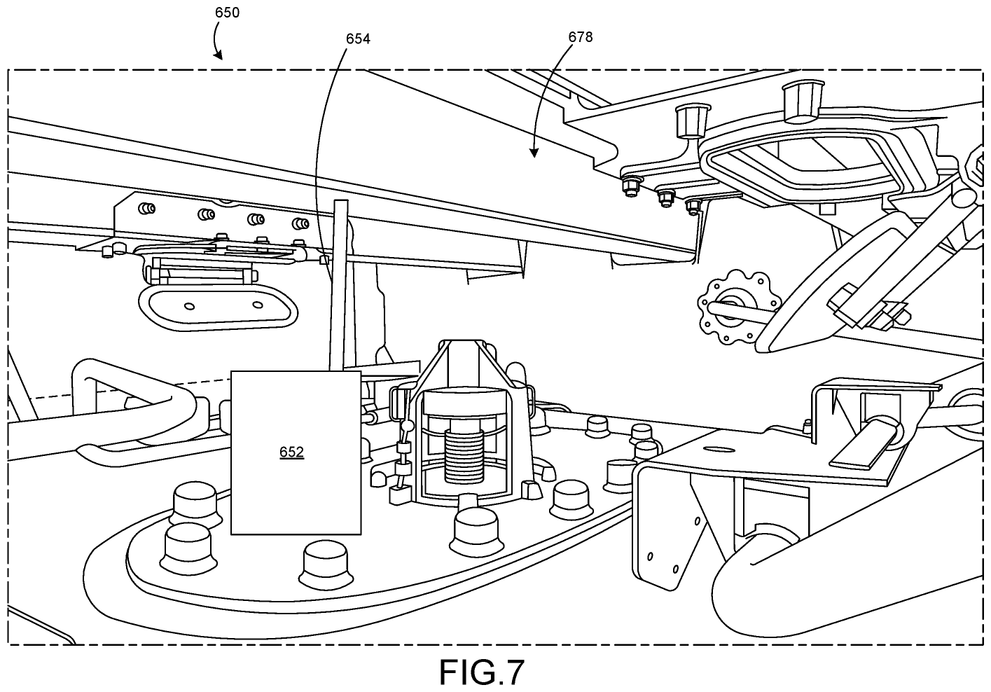

Referring now to FIGS. 6 and 7, an OPV system 650 according to another implementation is illustrated. The OPV system 650 includes an OPV valve 652 and a fluid connection 654. The OPV valve 652 is positioned within a surge tank 678 of the aircraft that is coupled in fluid communication with the fuel tank 102b (not shown in FIG. 7). The fluid connection 654 is operatively connected between the OPV valve 652 and the supply line 104 such that the OPV valve 652 is coupled in fluid communication with the supply line 104 through the fluid connection 654. As shown in FIG. 6, the fluid connection 654 is operatively connected to the supply line 104 upstream from the outlet 136b of the supply line 104 (and downstream from the outlet 130 of the GSM assembly 108). Accordingly, the OPV valve 652 is configured to sense the pressure within the supply line 104 at a location along the supply line 104 that is upstream from the outlet 136b of the supply line 104 (and downstream from the outlet 130).

The OPV valve 652 may be a regulating valve, a relief valve, a pneumatic mechanical valve that provides a direct response to physical phenomenon (e.g., over-pressure, etc.), a digital or analog electromechanical valve (operation of which is controlled by a controller, etc.), and/or the like.

The OPV system 650 functions substantially similar to the OPV system 150 (shown in FIG. 1) to facilitate mitigating over-pressurization of the fuel tanks 102. For example, the OPV valve 652 is configured such that when the pressure difference between the sensed pressure within the supply line 104 and the sensed atmospheric pressure is greater than the predetermined threshold, the OPV valve 652 opens to vent pressure from the supply line 104 into the surge tank 678 and thereby facilitate mitigating the over-pressurization situation.

Referring again to FIG. 1, each OPV valve described and/or illustrated herein (e.g., the OPV valve 152, etc.) may be a regulating valve, a relief valve, a pneumatic mechanical valve that provides a direct response to physical phenomenon (e.g., over-pressure, etc.), a digital or analog electromechanical valve (operation of which is controlled by a controller, etc.), and/or the like. When implemented as a regulating valve, each OPV valve described and/or illustrated herein is not limited to a pressure-loaded closed poppet valve, single or dual. Rather, any other type of regulating valve (e.g., including any valve architecture, etc.) may be used.

BIT can be performed to detect faults within the OPV systems disclosed herein. For example, a BIT can be performed to determine whether the regulating OPV valve 152 has failed open or failed closed. Specifically, the OPV valve 152 is set to the closed position and the isolation valves 140 are closed to prevent the flow of nitrogen-enriched gas to the fuel tanks 102. If there is a mass flow difference between the mass flow sensor 172a and the mass flow sensor 172b when the OPV valve 152 is closed, the OPV valve 152 has failed open. Upon a determination that the OPV valve 152 has failed open, a fault may be latched and a flight deck message sent that the OPV system 150 is in degraded mode. Alternatively, the flammability reduction system (FRS) can be shut down and a corresponding message sent to the flight deck.

If there is no mass flow difference between the mass flow sensors 172a and 172b when the OPV valve 152 should be open during an FRS system BIT, the OPV valve has failed closed. Upon a determination that the OPV valve 152 has failed closed, a fault may be latched and the FRS may be reduced or shut down because the OPV valve 152 venting functionality has failed.

Performance of a BIT to determine whether the OPV valve 552 shown in FIG. 5 has failed open or failed closed is substantially similar to the BIT described above with respect to determining whether the regulating OPV valve 152 has failed open or closed, with the exception that the isolation valve 576 would be used to prevent or enable actuation of the OPV valve 552.

In another example, a BIT can be performed to test the regulation ability of the OPV valve 152. First, the isolation valves 140 are closed to prevent the flow of nitrogen-enriched gas to the fuel tanks 102. The flow rate of the nitrogen-enriched gas in the NEADS 100 is gradually increased to further increase NEADS pressure where the OPV valve 152 regulates. Note that this test can incorporate failed open/closed with mass flow comparison without monitoring pressure (similar to the above described open/closed test but with gradual increase of the mass flow). As the flow increases, so does the pressure in a NEADS supply line (e.g., the supply line 104), and when the pressure difference between the NEADS supply line and the ambient pressure at the fairing penetration is sufficiently high, the OPV valve 152 will start opening and regulating pressure. When the OPV valve 152 is regulating, the pressure difference is maintained, which is a distinguishing feature used in the BIT to detect when the OPV valve 152 is regulating and when the OPV valve 152 is unable to regulate. The BIT further includes monitoring the pressure upstream of the OPV valve 152 (e.g., using the pressure sensor 174, etc.) and the pressure difference from the ambient pressure signal (pressure at altitude). Correlation between the flow rate and the start and stop of the regulation abilities are used to fault the OPV valve 152 in the intermediate position. The BIT can use characterization of corrected flow, such as standard flow (corrected flow to 1 atm pressure and 15° C./59° F. temperature), or some empirically determined correlation vs Δp because there is temperature measurement (within the mass flow sensor, or can be separate) and a pressure sensor. If the spring rate increases (due to failures), the regulation point will shift up (higher pressure) or the OPV valve 152 will stop regulating at a lower pressure (the slope moves to lower mass flow). The threshold of acceptable range for the maximum flow and drift allowed may be determined by overpressure analysis. Trend analysis can be used to detect drift and anticipate faults.

Note that the pressure at altitude need not be exactly the same as the pressure acting on the OPV valve 152 from the fairing penetration, but would be correlated. Furthermore, what is being looked at during the BIT is not necessarily the absolute difference, but the change in slope; both the absolute difference and the change of slope can be used in prognostics and health monitoring to recognize when the OPV valve 152 may be exhibiting wear.

Performance of a BIT to determine the regulation ability of the relief OPV valve 552 shown in FIG. 5 is substantially similar to the BIT described above with respect to determining the regulating ability of the OPV valve 152, with the exception that instead of monitoring the pressure difference, the flow through the OPV valve 552 can be inferred by the difference in the two mass flow sensors 172a and 172b and a correlation (corrected flow, such as standard flow correction to 1 atm and 15° C., or an empirical function vs. Δp) can be made with the pressure difference between the pressure sensor (between the mass flow sensors) and the pressure at altitude signal.

In implementations wherein the OPV system 150 only includes one mass flow sensor 172, BITs may be performed using one or more threshold flow rates instead of the difference between the flow rates of different mass flow sensors.

FIG. 8 illustrates a method 700 of venting pressure from a NEADS (e.g., the NEADS 100 shown in FIGS. 1 and 5, etc.) of a fuel tank (e.g., the fuel tanks 102a, 102b, and 102c shown in FIG. 1, etc.) according to an implementation. The method 700 includes coupling, at 702, an OPV valve in fluid communication with a supply line of the NEADS upstream from an outlet of the supply line through which the supply line delivers NEA to the fuel tank. At 704, the method 700 includes sensing a pressure within the supply line upstream from the outlet of the supply line. At 706, the method 700 includes operating the OPV valve to vent pressure from the supply line upstream from the outlet of the supply line based on the pressure sensed within the supply line.

In some implementations, sensing at 704 the pressure within the supply line upstream from the outlet of the supply line includes sensing, at 704a, the pressure through a pressure sense line that is coupled in fluid communication with the supply line upstream from the outlet of the supply line and downstream from OPV valve. In some implementations, sensing at 704 the pressure within the supply line upstream from the outlet of the supply line optionally includes sensing, at 704b, the pressure through an integrated pressure sense line that is coupled in fluid communication with the supply line upstream from the outlet of the supply line.

Optionally, sensing at 704 the pressure within the supply line upstream from the outlet of the supply line includes sensing, at 704c, an atmospheric pressure reference. In some implementations, sensing at 704 the pressure within the supply line upstream from the outlet of the supply line includes determining, at 704d, a pressure difference between the sensed pressure within the supply line and an atmospheric pressure.

In some implementations, operating at 706 the OPV valve to vent pressure from the supply line upstream from the outlet of the supply line based on the pressure sensed within the supply line includes venting, at 706a, pressure from the supply line if a pressure difference between the sensed pressure within the supply line and an atmospheric pressure is greater than a predetermined threshold value.

Referring now to FIG. 9, examples of the present application may be described in the context of using the OPV systems disclosed herein on an aircraft 800 that includes an airframe 802. The aircraft 800 includes a plurality of high-level systems 804 and an interior 806. Examples of high-level systems 804 include one or more of a propulsion system 808, an electrical system 810, a hydraulic fluid system 812, a control system 814, and an environmental system 816. Any number of other systems can be included. Although a fixed wing passenger aircraft is shown, the OPV systems described and/or illustrated herein can be used with any other type of aircraft, such as, but not limited to, transport aircraft, military aircraft, rotorcraft (e.g., helicopters, etc.), lighter than air vehicles (e.g., balloons, etc.), and/or the like. Moreover, although an aerospace example is shown, the present application can be applied to other industries, such as, but not limited to, the automotive industry, the marine industry, etc.

The following clauses describe further aspects:

### Clause Set A:

A1. An over-pressure vent (OPV) system for a fuel tank of an aircraft, the OPV system comprising:
an OPV valve configured to be coupled in fluid communication with a supply line of a nitrogen enriched air distribution system (NEADS) such that the OPV valve is configured to vent pressure from the supply line, the OPV valve being configured to be coupled in fluid communication with the supply line upstream from an outlet of the supply line from which the NEADS delivers nitrogen enriched gas to the fuel tank, the OPV valve being configured to sense a pressure within the supply line upstream from the outlet of the supply line.
   A2. The OPV system of any preceding clause, wherein the OPV valve comprises a regulating valve.
   A3. The OPV system of any preceding clause, wherein the OPV valve comprises a relief valve.
   A4. The OPV system of any preceding clause, wherein the OPV valve comprises a relief valve, the OPV system further comprising an isolation valve configured to be coupled in fluid communication with the supply line of the NEADS upstream from the OPV valve.
   A5. The OPV system of any preceding clause, wherein the OPV valve comprises a dual poppet valve.
   A6. The OPV system of any preceding clause, further comprising a pressure sense line configured to be coupled in fluid communication with the supply line of the NEADS upstream from the outlet of the supply line and downstream from OPV valve, the pressure sense line being coupled in fluid communication with the OPV valve such that the OPV valve is configured to sense the pressure within the supply line through the pressure sense line.
   A7. The OPV system of any preceding clause, wherein the OPV valve comprises an integrated pressure sense line that is configured to be coupled in fluid communication with the supply line of the NEADS upstream from the outlet of the supply line, the OPV valve being configured to sense the pressure within the supply line through the integrated pressure sense line.
   A8. The OPV system of any preceding clause, further comprising at least one mass flow sensor configured to be coupled in fluid communication with the supply line of the NEADS for sensing a flow rate within the supply line.
   A9. The OPV system of any preceding clause, wherein the OPV valve is configured to be coupled in fluid communication with the supply line of the NEADS between first and second mass flow sensors.
   A10. The OPV system of any preceding clause, wherein the outlet of the supply line is a first outlet of the supply line, the OPV valve being configured to be coupled in fluid communication with the supply line of the NEADS upstream from a junction at which the supply line branches off to the first outlet and a second outlet of the supply line.

### Clause set B:

B1. A nitrogen enriched air distribution system (NEADS) comprising:
a supply line comprising an outlet configured to be coupled in fluid communication with a fuel tank, the supply line being configured to deliver nitrogen enriched gas to the fuel tank through the outlet; and
an over-pressure vent (OPV) valve coupled in fluid communication with the supply line such that the OPV valve is configured to vent pressure from the supply line, the OPV valve being coupled in fluid communication with the supply line upstream from the outlet of the supply line, the OPV valve being configured to sense a pressure within the supply line upstream from the outlet of the supply line.
   B2. The NEADS of any preceding clause, wherein the OPV valve comprises a regulating valve.
   B3. The NEADS of any preceding clause, wherein the OPV valve comprises a relief valve.
   B4. The NEADS of any preceding clause, wherein the OPV valve comprises a relief valve, the NEADS further comprising an isolation valve coupled in fluid communication with the supply line upstream from the OPV valve.
   B5. The NEADS of any preceding clause, wherein the OPV valve comprises a dual poppet valve.
   B6. The NEADS of any preceding clause, further comprising a pressure sense line coupled in fluid communication with the supply line upstream from the outlet of the supply line and downstream from OPV valve, the pressure sense line being coupled in fluid communication with the OPV valve such that the OPV valve is configured to sense the pressure within the supply line through the pressure sense line.
   B7. The NEADS of any preceding clause, wherein the OPV valve comprises an integrated pressure sense line that is coupled in fluid communication with the supply line upstream from the outlet of the supply line, the OPV valve being configured to sense the pressure within the supply line through the integrated pressure sense line.
   B8. The NEADS of any preceding clause, further comprising at least one mass flow sensor configured coupled in fluid communication with the supply line of the NEADS for sensing a flow rate within the supply line.
   B9. The NEADS of any preceding clause, further comprising first and second mass flow sensors coupled in fluid communication with the supply line for sensing a flow rate within the supply line, wherein the OPV valve is coupled in fluid communication with the supply line between the first and second mass flow sensors.
   B10. The NEADS of any preceding clause, wherein the outlet of the supply line is a first outlet of the supply line, the supply line comprising a second outlet and a junction at which the supply line branches off to the first and second outlets, the OPV valve being coupled in fluid communication with the supply line upstream from the junction.

### Clause set C:

C1. A method of venting pressure from a nitrogen enriched air distribution system (NEADS) of a fuel tank, the method comprising:
coupling an over-pressure vent (OPV) valve in fluid communication with a supply line of the NEADS upstream from an outlet of the supply line through which the supply line delivers nitrogen enriched gas to the fuel tank;
sensing a pressure within the supply line upstream from the outlet of the supply line; and
operating the OPV valve to vent pressure from the supply line upstream from the outlet of the supply line based on the pressure sensed within the supply line.
   C2. The method of any preceding clause, wherein sensing the pressure within the supply line upstream from the outlet of the supply line comprises sensing the pressure through a pressure sense line that is coupled in fluid communication with the supply line upstream from the outlet of the supply line and downstream from OPV valve.
   C3. The method of any preceding clause, wherein sensing the pressure within the supply line upstream from the outlet of the supply line comprises sensing the pressure through an integrated pressure sense line that is coupled in fluid communication with the supply line upstream from the outlet of the supply line.
   C4. The method of any preceding clause, wherein sensing the pressure within the supply line upstream from the outlet of the supply line comprises sensing an atmospheric pressure reference.
   C5. The method of any preceding clause, wherein sensing the pressure within the supply line upstream from the outlet of the supply line comprises determining a pressure difference between the sensed pressure within the supply line and an atmospheric pressure.
   C6. The method of any preceding clause, wherein operating the OPV valve to vent pressure from the supply line upstream from the outlet of the supply line based on the pressure sensed within the supply line comprises venting pressure from the supply line if a pressure difference between the sensed pressure within the supply line and an atmospheric pressure is greater than a predetermined threshold value.

As used herein, a structure, limitation, or element that is “configured to” perform a task or operation is particularly structurally formed, constructed, or adapted in a manner corresponding to the task or operation. For purposes of clarity and the avoidance of doubt, an object that is merely capable of being modified to perform the task or operation is not “configured to” perform the task or operation as used herein.

Any range or value given herein can be extended or altered without losing the effect sought, as will be apparent to the skilled person.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above can relate to one implementation or can relate to several implementations. The implementations are not limited to those that solve any or all of the stated problems or those that have any or all of the stated benefits and advantages. It will further be understood that reference to ‘an’ item refers to one or more of those items.

The order of execution or performance of the operations in examples of the present application illustrated and described herein is not essential, unless otherwise specified. That is, the operations can be performed in any order, unless otherwise specified, and examples of the application can include additional or fewer operations than those disclosed herein. For example, it is contemplated that executing or performing a particular operation before, contemporaneously with, or after another operation (e.g., different steps, etc.) is within the scope of aspects and implementations of the application.

The term “comprising” is used in this specification to mean including the feature(s) or act(s) followed thereafter, without excluding the presence of one or more additional features or acts. The terms “comprising,” “including,” and “having” are intended to be inclusive and mean that there can be additional elements other than the listed elements. In other words, the use of “including,” “comprising,” “having,” “containing,” “involving,” and variations thereof, is meant to encompass the items listed thereafter and additional items. Accordingly, and for example, unless explicitly stated to the contrary, implementations “comprising” or “having” an element or a plurality of elements having a particular property can include additional elements not having that property. Further, references to “one implementation” or “an implementation” are not intended to be interpreted as excluding the existence of additional implementations that also incorporate the recited features. The term “exemplary” is intended to mean “an example of”.

When introducing elements of aspects of the application or the examples thereof, the articles “a,” “an,” “the,” and “said” are intended to mean that there are one or more of the elements. In other words, the indefinite articles “a”, “an”, “the”, and “said” as used in the specification and in the claims, unless clearly indicated to the contrary, should be understood to mean “at least one.” Accordingly, and for example, as used herein, an element or step recited in the singular and preceded by the word “a” or “an” should be understood as not necessarily excluding the plural of the elements or steps.

The phrase “one or more of the following: A, B, and C” means “at least one of A and/or at least one of B and/or at least one of C.” The phrase “and/or”, as used in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one implementation, to A only (optionally including elements other than B); in another implementation, to B only (optionally including elements other than A); in yet another implementation, to both A and B (optionally including other elements); etc.

As used in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of or “exactly one of,” or, when used in the claims, “consisting of,” will refer to the inclusion of exactly one element of a number or list of elements. In general, the term “or” as used shall only be interpreted as indicating exclusive alternatives (i.e. “one or the other but not both”) when preceded by terms of exclusivity, such as “either,” “one of “only one of or “exactly one of.” “Consisting essentially of,” when used in the claims, shall have its ordinary meaning as used in the field of patent law.

As used in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one implementation, to at least one, optionally including more than one, A, with no B present (and optionally including elements other than B); in another implementation, to at least one, optionally including more than one, B, with no A present (and optionally including elements other than A); in yet another implementation, to at least one, optionally including more than one, A, and at least one, optionally including more than one, B (and optionally including other elements); etc.

Use of ordinal terms such as “first,” “second,” “third,” etc., in the claims to modify a claim element does not by itself connote any priority, precedence, or order of one claim element over another or the temporal order in which acts of a method are performed. Ordinal terms are used merely as labels to distinguish one claim element having a certain name from another element having a same name (but for use of the ordinal term), to distinguish the claim elements.

Having described aspects of the application in detail, it will be apparent that modifications and variations are possible without departing from the scope of aspects of the application as defined in the appended claims. As various changes could be made in the above constructions, products, and methods without departing from the scope of aspects of the application, it is intended that all matter contained in the above description and shown in the accompanying drawings shall be interpreted as illustrative and not in a limiting sense.

It is to be understood that the above description is intended to be illustrative, and not restrictive. For example, the above-described implementations (and/or aspects thereof) can be used in combination with each other. In addition, many modifications can be made to adapt a particular situation or material to the teachings of the various implementations of the application without departing from their scope. While the dimensions and types of materials described herein are intended to define the parameters of the various implementations of the application, the implementations are by no means limiting and are example implementations. Many other implementations will be apparent to those of ordinary skill in the art upon reviewing the above description. The scope of the various implementations of the application should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112 (f), unless and until such claim limitations expressly use the phrase “means for” followed by a statement of function void of further structure.

This written description uses examples to disclose the various implementations of the application, including the best mode, and also to enable any person of ordinary skill in the art to practice the various implementations of the application, including making and using any devices or systems and performing any incorporated methods. The patentable scope of the various implementations of the application is defined by the claims, and can include other examples that occur to those persons of ordinary skill in the art. Such other examples are intended to be within the scope of the claims if the examples have structural elements that do not differ from the literal language of the claims, or if the examples include equivalent structural elements with insubstantial differences from the literal language of the claims.

What is claimed is:

1. An over-pressure vent (OPV) system for a fuel tank of an aircraft, the OPV system comprising:
an OPV valve in fluid communication with a supply line of a nitrogen enriched air distribution system (NEADS) such that the OPV valve is capable of venting pressure from the supply line, the OPV valve being coupled in fluid communication with the supply line upstream from an outlet of the supply line from which the NEADS delivers nitrogen enriched gas to the fuel tank, the OPV valve capable of sensing pressure within the supply line upstream from the outlet of the supply line;
the OPV system further comprising a controller; the controller capable of opening the OPV valve whenever a difference between a sensed pressure within the supply line and ambient pressure exceeds a predetermined threshold; and
wherein the OPV valve further comprises a selectively moveable pilot valve operable by the controller to deactivate the OPV valve during descent phases of aircraft flight.

2. The OPV system of claim 1, wherein the OPV valve comprises a regulating valve.

3. The OPV system of claim 1, wherein the OPV valve comprises a relief valve.

4. The OPV system of claim 1, wherein the OPV valve comprises a relief valve, the OPV system further comprising an isolation valve capable of being coupled in fluid communication with the supply line of the NEADS upstream from the OPV valve.

5. The OPV system of claim 1, further comprising a pressure sense line capable of being coupled in fluid communication with the supply line of the NEADS upstream from the outlet of the supply line, the pressure sense line being coupled in fluid communication with the OPV valve such that the OPV valve is capable of sensing the pressure within the supply line through the pressure sense line.

6. The OPV system of claim 1, wherein the OPV valve comprises an integrated pressure sense line that is capable of being coupled in fluid communication with the supply line of the NEADS upstream from the outlet of the supply line, the OPV valve being capable of sensing the pressure within the supply line through the integrated pressure sense line.

7. The OPV system of claim 1, further comprising at least one mass flow sensor capable of being coupled in fluid communication with the supply line of the NEADS for sensing a flow rate within the supply line.

8. The OPV system of claim 1, wherein the OPV valve is capable of being coupled in fluid communication with the supply line of the NEADS between first and second mass flow sensors.

9. The OPV system of claim 1, wherein the outlet of the supply line is a first outlet of the supply line, the OPV valve being capable of being coupled in fluid communication with the supply line of the NEADS upstream from a junction at which the supply line branches off to the first outlet and a second outlet of the supply line.

10. A nitrogen enriched air distribution system (NEADS) comprising:
a supply line comprising an outlet in fluid communication with a fuel tank, the supply line being capable of delivering nitrogen enriched gas to the fuel tank through the outlet; and
an over-pressure vent (OPV) valve coupled in fluid communication with the supply line such that the OPV valve is capable of venting pressure from the supply line, the OPV valve being coupled in fluid communication with the supply line upstream from the outlet of the supply line, the OPV valve being capable of sensing a pressure within the supply line upstream from the outlet of the supply line;
the OPV system further comprising a controller; the controller capable of opening the OPV valve whenever a difference between a sensed pressure within the supply line and ambient pressure exceeds a predetermined threshold; and
wherein the OPV valve further comprises a selectively moveable pilot valve operable by the controller to deactivate the OPV valve during descent phases of aircraft flight.

11. The NEADS of claim 10, wherein the OPV valve comprises at least one of a regulating valve, a relief valve, or a dual poppet valve.

12. The NEADS of claim 10, wherein the OPV valve comprises a relief valve, the NEADS further comprising an isolation valve coupled in fluid communication with the supply line upstream from the OPV valve.

13. The NEADS of claim 10, further comprising a pressure sense line coupled in fluid communication with the supply line upstream from the outlet of the supply line, the pressure sense line being coupled in fluid communication with the OPV valve such that the OPV valve is capable of sensing the pressure within the supply line through the pressure sense line.

14. The NEADS of claim 10, wherein the OPV valve comprises an integrated pressure sense line that is coupled in fluid communication with the supply line upstream from the outlet of the supply line, the OPV valve being capable of sensing the pressure within the supply line through the integrated pressure sense line.

15. The NEADS of claim 10, further comprising at least one mass flow sensor capable of being coupled in fluid communication with the supply line of the NEADS for sensing a flow rate within the supply line.

16. A method of venting pressure from a nitrogen enriched air distribution system (NEADS) of a fuel tank, the method comprising:
coupling an over-pressure vent (OPV) valve in fluid communication with a supply line of the NEADS upstream from an outlet of the supply line through which the supply line delivers nitrogen enriched gas to the fuel tank;
enabling the OPV valve to sense a pressure within the supply line upstream from the outlet of the supply line;
providing a controller to operate the OPV system; the controller being capable of opening the OPV valve whenever a difference between a sensed pressure within the supply line and ambient pressure exceeds a predetermined threshold; and
providing the OPV valve with a selectively moveable pilot valve operable by the controller to deactivate the OPV valve during descent phases of aircraft flight.

17. The method of claim 16, wherein the OPV valve senses an atmospheric pressure reference.

18. The method of claim 16, wherein sensing the pressure within the supply line upstream from the outlet of the supply line enables the OPV valve to determine a pressure difference between the sensed pressure within the supply line and an atmospheric pressure.

19. The method of claim 16, wherein enabling the OPV valve to sense pressure within the supply line upstream from the outlet of the supply line enables the OPV valve to automatically vent pressure from the supply line if a pressure difference between the sensed pressure within the supply line and an atmospheric pressure is greater than a predetermined threshold value.

20. The OPV system of claim 1, wherein the selectively moveable pilot valve operable by the controller to deactivate the OPV valve is to prevent venting of the OPV valve during higher supply line pressures occurring during descent phases of aircraft flight.
